(19) United States
(12) Patent Application Publication
(10) Pub. No.: US 2010/0082341 A1
(43) Pub. Date: Apr. 1, 2010

(54) Speaker recognition device and method using voice signal analysis

(75) Inventor: Hyun-Soo Kim, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/586,853

(22) Filed: Sep. 29, 2009

(30) Foreign Application Priority Data
Sep. 30, 2008 (KR) 10-2008-0096315

(51) Int. Cl. G10L 15/20; G10L 17/00

(52) U.S. Cl. 704/233; 704/246; 704/E17.001; 704/E15.039

(57) ABSTRACT

A device includes a speaker recognition device operable to perform a method that identifies a speaker using voice signal analysis. The speaker recognition device and method identifies the speaker by analyzing a voice signal and comparing the signal with voice signal characteristics of speakers, which are statistically classified. The device and method is applicable to a case where a voice signal is a voiced sound or a voiceless sound or to a case where no information on a voice signal is present. Since voice/non-voice determination is performed, the speaker can be reliably identified from the voice signal. The device and method is adaptable to applications that require a real-time process due to a small amount of data to be calculated and fast processing. Furthermore, the device and method can be variously applied to portable devices due to low power consumption.

### CROSS-REFERENCE TO RELATED APPLICATION(S) AND CLAIM OF PRIORITY

The present application is related to and claims the benefit under 35 U.S.C. §119 (a) of a Korean patent application filed in the Korean Intellectual Property Office on Sep. 30, 2008, and there duly assigned Serial No. 10-2008-0096315, the entire disclosure of which is hereby incorporated by reference.

### TECHNICAL FIELD OF THE INVENTION

The present invention relates to a speaker recognition device and method using voice signal analysis, and more particularly, to a speaker recognition device and method capable of more quickly and easily recognizing a speaker using the periodicity of a voice signal.

More particularly, the present invention relates to a speaker recognition device and method which can quickly and easily recognize a speaker using the periodicity of a voice signal by separating a specific pattern signal from a voice signal frame, comparing the separated specific pattern signal with information stored in a database to determine whether the voice frame is a voice signal, if the voice frame is a voice signal, measuring periodicity information of the voice frame using the specific pattern signal, and comparing the measured periodicity information with speaker-specific voice information stored in the database.

### BACKGROUND OF THE INVENTION

Conventional speaker recognition methods use pitch information (for example, the periodicity of a voice signal) extracted from the voice signal using a variety of pitch information extraction methods in order to recognize a speaker. The pitch information extraction methods are carried out using Linear Prediction (LP) analysis that predicts a next signal based on a prior signal. The performance of the LP analysis depends on the order of LP. However, simply raising the order to enhance the performance results in not only an increase in the amount of data to be calculated but also limited performance.

An important drawback of the LP analysis is that it operates on the assumption that a signal is stabilized in a short period of time. This scheme fails to analyze a signal that rapidly changes, especially, in a transition region of a voice signal since it is not able to follow the rapidly-changing signal.

Another limitation of the LP analysis involves the application of data windowing. The selection of the data windowing is a trade-off between time and frequency axis resolution. For example, in the case of a voice having a very high pitch, the LP analysis (in which autocorrelation and covariance methods are most representative) follows respective harmonics rather than the envelope of a spectrum owing to the great distance of harmonic regions.

The LP analysis operates on the assumption that a vocal tract transfer function can be modeled by a linear all-pole model. This tends to show poor performance, especially, in the case of a female or child speaker.

The conventional pitch information extraction method for recognizing a speaker selects a frequency regarded as an optimal candidate in the corresponding algorithm. However, a fine error ratio occurs due to the limited performance of the algorithm. (The error tends to increase along with noises.) Enormous errors can be caused in the entire input voice frames due to pitch doubling or pitch halving.

The conventional speaker recognition method inefficiently processes a non-voice signal similar to a voice signal by determining it as a voice signal.

### SUMMARY OF THE INVENTION

To address the above-discussed deficiencies of the prior art, it is a primary object to provide an efficient device and method that can analyze a reliable voice signal that includes a small amount of data to be calculated.

Aspects of the present invention also provide a more efficient device and method that can perform analysis according to the periodicity of a voice signal.

Aspects of the present invention also provide a device and method that can distinguish a voice signal from a non-voice signal by comparing the pattern of an analyzed signal with pattern information of stored voice/non-voice signals.

Aspects of the present invention also provide a device and method that can identify a speaker by comparing an analyzed voice signal with stored information of voice characteristics of speakers.

According to an aspect of the invention, the speaker recognition method include separating a specific pattern signal from an input frame by analyzing the frame; determining whether the specific pattern signal is a voice signal or a non-voice signal by comparing the specific pattern signal with information in a Database (DB) that is statistically processed; measuring periodicity of the frame if the specific pattern signal is determined to be a voice signal; and recognizing a speaker of the frame based on the measured periodicity of the frame.

In an exemplary embodiment, the step of separating a specific pattern signal from an input frame can separate the specific pattern signal by Harmonic-to-Noise Decomposition (HND) if the frame is a voiced sound and by Sinusoidal-to-Non-sinusoidal Decomposition (SND) if the frame is a voiceless sound or no information on the frame is present.

According to another aspect of the invention, the speaker recognition device includes an input to which a voice signal frame is applied; a processor configured to separate a specific pattern signal by analyzing the voice signal frame; a DB containing pattern information according to characteristics of the specific pattern signal; a comparator configured to compare the specific pattern signal with information stored in the DB; a periodicity measurer that obtains periodicity of the voice signal frame from the specific pattern signal; and a discriminator that recognizes a speaker of the voice signal from based on the periodicity.

According to exemplary embodiments of the invention, the speaker recognition device and method using voice signal analysis can separate a voice signal using an optimal algorithm according to the periodicity of the voice signal.

Even if no information on the periodicity of the voice signal is present, the voice signal can be analyzed.

In addition, only a reliable voice signal can be analyzed through voice signal verification.

Furthermore, the device and method can reduce power consumption since a voice signal can be separated by an optimal method.

Moreover, a speaker can be more rapidly and accurately identified from a population of speakers since the speaker is recognized by comparing it with information, which is stored according to the characteristics of the speakers. For example, the speaker can be identified in real-time according to the characteristics of speakers present in a conference. Speeches can be discriminated according to the speakers since voice frames are stored according to the characteristics of the speakers.

Other aspects and features of the invention will be apparent from or are set forth in more detail in the accompanying drawings, which are incorporated herein, and the following Detailed Description of the Invention, which together serve to explain certain principles of the present invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram for the configuration of a speaker recognition device according to an exemplary embodiment of the invention;

FIG. 2 illustrates a block diagram for the configuration of a separator according to an exemplary embodiment of the invention;

FIG. 3 illustrates a block diagram for the configuration of a processor according to an exemplary embodiment of the invention;

FIG. 4 illustrates a block diagram for the configuration of a periodicity measurer according to an exemplary embodiment of the invention;

FIG. 5 illustrates a flowchart for a speaker recognition method using voice signal analysis according to an exemplary embodiment of the invention;

FIG. 6 illustrates graphs for a case where a harmonic region of a voice signal is periodic and a case where the harmonic region of a voice signal is aperiodic;

FIG. 7 illustrates a flowchart for an HND process according to an exemplary embodiment of the invention;

FIG. 8 illustrates a flowchart for an SND process according to an exemplary embodiment of the invention;

FIG. 9 illustrates a graph of a voice signal before harmonic regions and a noise regions are separated by the HND or SND process according to an exemplary embodiment of the invention;

FIG. 10 illustrates a graph of a signal in harmonic regions separated by the HND or SND process according to an exemplary embodiment of the invention; and

FIG. 11 illustrates a graph of a signal in noise regions separated by the HND or SND process according to an exemplary embodiment of the invention.

### DETAILED DESCRIPTION OF THE INVENTION

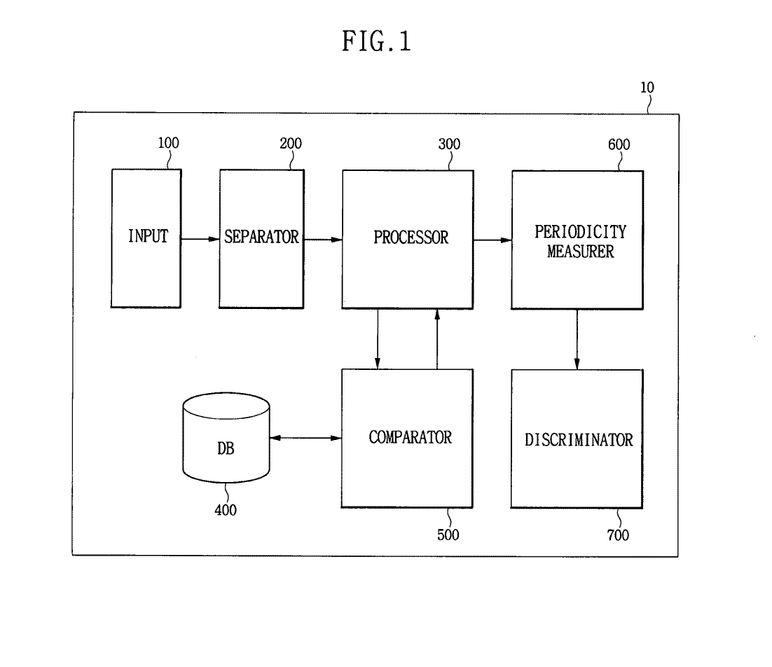

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged voice processing system.

Terminologies used herein are intended to be in the nature of description rather than of limiting the scope of the present invention defined in the claims. The terminologies are used for the purposes of discriminating one component from another.

While the terminologies used herein are used to describe specific exemplary embodiments, it should not be understood to limit the present invention. Unless explicitly described to the contrary, a singular expression includes a plural concept. Furthermore, the terminologies such as “comprising,” “including,” and “having” are used to designate features, numbers, steps, operations, components, parts, or combinations thereof described herein. It should be understood that they do not exclude the possibility of the existence or addition of one or more other features, numbers, steps, operations, components, parts, or combinations.

Exemplary embodiments of the invention will now be described hereinafter with reference to the accompanying drawings.

FIG. 1 illustrates a block diagram for the configuration of a speaker recognition device 10 according to an exemplary embodiment of the invention.

According to some embodiments, the speaker recognition device 10 includes an input 100, a separator 200, a processor 300, a database (DB) 400, a comparator 500, a periodicity measurer 600, and a discriminator 700.

The input 100 is a constitutional part into which a voice frame is input. If the input voice frame is a time frame, the input 100 can convert the voice frame into a frequency range. The voice frame can be converted into the frequency range using Fourier conversion. Methods of converting the voice frame into the frequency range are well-known in the art, and thus a description thereof will be omitted.

The separator 200 examines frequency characteristics of an input voice frame and divides a voiced sound from a voiceless sound based on the frequency characteristics. The separator 200 can also include a Digital Signal Processor (DSP) that examines frequency characteristics. The separator 200 determines the input voice frame to be a voiced sound if it has periodicity as a result of DSP. The separator 200 determines the input voice frame to be a voiceless sound if it has a periodicity as a result of DSP. The separator 200 can be excluded if the voice frame from the input 100 is discriminated according to the voiced and voiceless sounds.

The processor 300 separates a signal that includes a specific pattern by analyzing a voice frame. The processor 300 can also include a DSP processor that executes difference processes according to the types of voice frames. A detailed description of the processor 300 will be given later with reference to FIG. 3.

The DB 400 can store information of signals that each include a specific pattern, which is classified by the processor 300. The signals are classified according to signal characteristics statistically defined by the patterns. The signal characteristics defined by the patterns can include various types of information, and particularly, pattern-specific information, based on which a voice frame containing pure voice information can be discriminated from a non-voice frame that does not contain voice information even if it is similar to the voice frame. The DB is implemented with a storage medium that contains information. For example, the DB can be, but is not limited to, a memory or a hard disk such as a Read Only Memory (ROM), a Random Only Memory (RAM) and a Flash Read Only Memory (FROM); or a mobile storage medium such as a Secure Digital (SD) card, a Compact Flash (CF) card, a Compact Disc Read Only Memory (CD-ROM), and a Solid State Disc (SSD).

The comparator 500 can compare a specific pattern signal, divided by the processor 300, with information stored in the DB to determine whether the pattern signal is a voice or non-voice signal. If the pattern signal is determined to be a voice signal as a result of the comparison, the comparator 500 generates a control signal. The comparator 500 can send the control signal to the processor 300, thereby controlling the processor 300 to send the divided pattern signal to the periodicity measurer 600. In addition, the comparator 500 can also serve to discard the pattern signal if the pattern signal is determined to a non-voice signal as a result of the comparison.

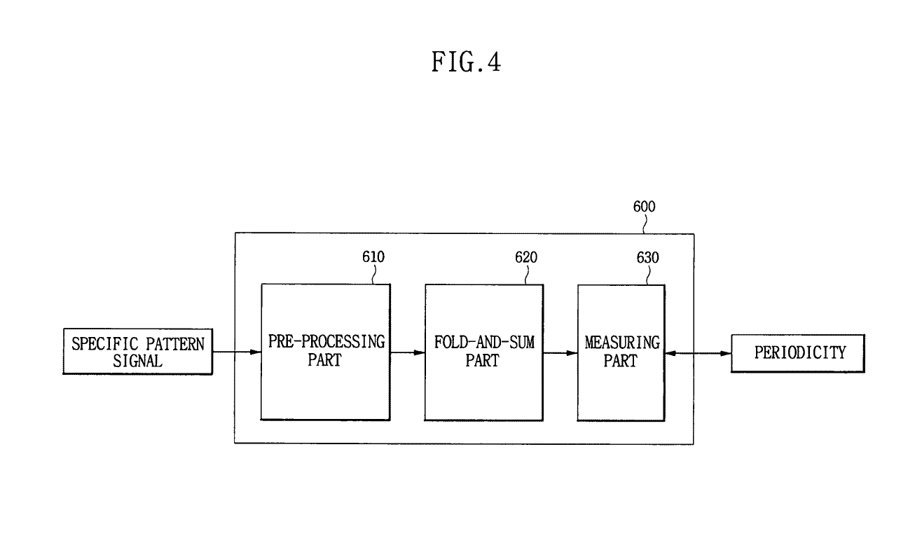

The periodicity measurer 600 is configured to measure the periodicity of a voice frame by performing DSP on a specific pattern signal input from the processor 300. The periodicity measurer 600 can include a DSP chip in order to perform DSP. A detailed description of the periodicity measurer 600 will be given later with reference to FIG. 4.

The discriminator 700 can recognize a speaker of a voice frame based on the periodicity information of the voice frame. The discriminator 700 recognizes the speaker by comparing the periodicity of the voice frame with periodicity information on speaker-specific characteristics. The periodicity information on speaker-specific characteristics can be stored in a storage medium, which can be included in the discriminator 700 or in a separate storage device.

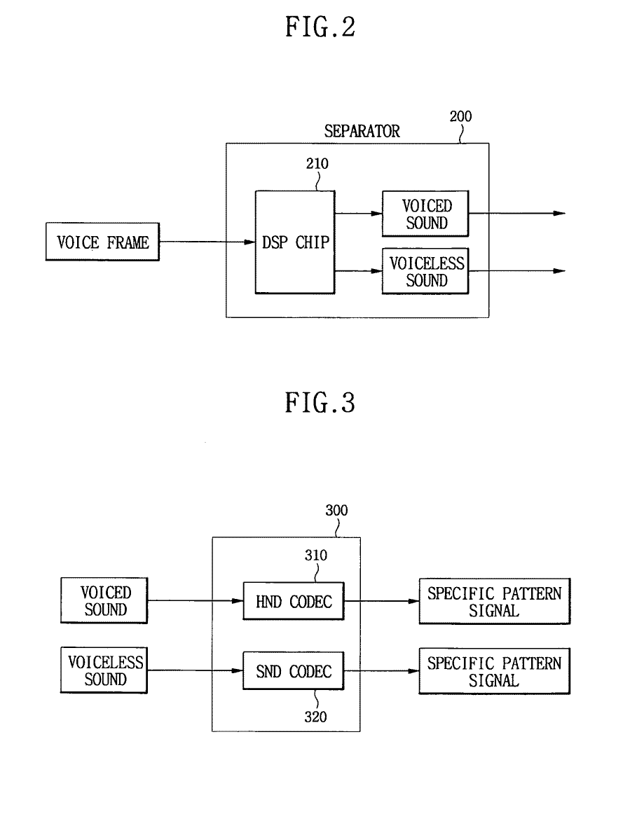

FIG. 2 illustrates a block diagram for the configuration of the separator 200 according to an exemplary embodiment of the invention.

The separator 200 can include a DSP chip 210 that processes digital signals. The DSP chip 210 discriminates the periodicity of an input voice frame by digital signal processing and thereby determines the input voice frame to be a voiced sound if it is periodic or to be a voiceless sound if it is aperiodic. The DSP chip can perform the digital signal processing and the periodicity determination. The process of discriminating voiced and voiceless sounds based on periodicity is well known in the art, and thus a detailed description thereof will be omitted.

FIG. 3 illustrates a block diagram for the configuration of the processor 300 according to an exemplary embodiment of the invention.

The processor 300 can include a Harmonic-to-Noise Decomposition (HND) codec 310 and a Sinusoidal-to-Non-sinusoidal Decomposition (SND) codec 320.

When a voice frame is a voiced sound, the HND codec separates a specific pattern signal from the voice frame. If the voice frame is a voiceless sound, the SND codec 320 separates a specific pattern signal from the voice frame. Accordingly, the processor 300 carries out different processes according to whether the input voice frame is a voiced or voiceless sound.

The HND codec 310 and the SND codec 320 can be integrated in one DSP chip or be implemented with separate DSP chips.

FIG. 4 illustrates a block diagram for the configuration of the periodicity measurer 600 according to an exemplary embodiment of the invention.

The periodicity measurer 600 can include a pre-processing part 610, a fold-and-sum part 620, and a measuring part 630.

The pre-processing part 610 is configure to remove a cascade wave component from a specific pattern signal.

The fold-and-sum part 620 carries out an operation by folding pre-processed signals “n” times and summing all the n times-folded signals.

The measuring part 630 measures a periodicity, which is the period of a representative signal of a voice signal frame, from the peak of the maximum region of a signal after a fold-and-sum operation is carried out on the signal.

The pre-processing part 610, the fold-and-sum part 620, and the measuring part 630 can be integrated into one DSP chip or be implemented with separate DSP chips.

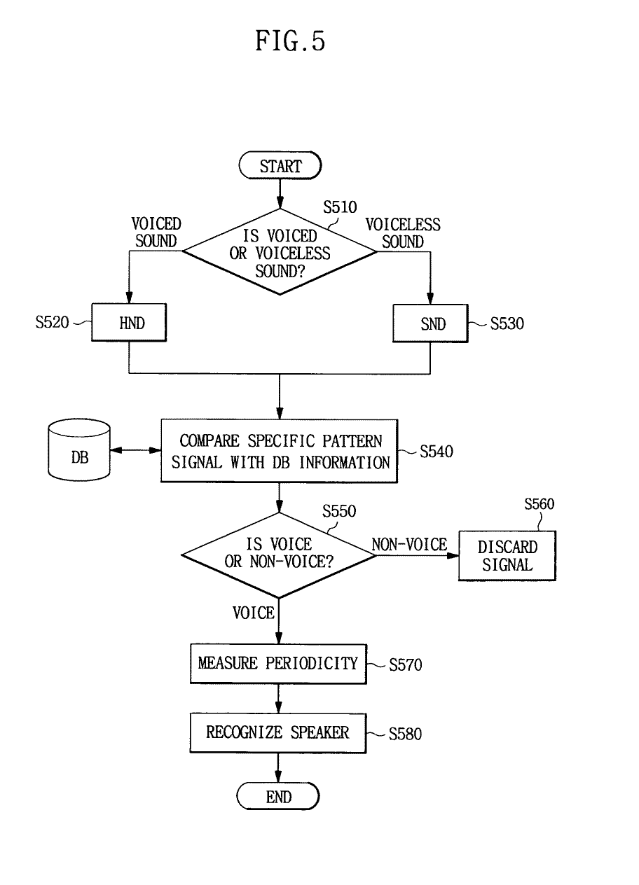

FIG. 5 illustrates a flowchart for a speaker recognition method using voice signal analysis according to an exemplary embodiment of the invention.

When a voice frame is input, it is determined whether the input voice frame is a voice or voiceless sound in step S510.

If the input voice frame is determined to be a voice sound, a specific pattern signal is extracted from the voice frame by an HND process in step S520. If the input voice frame is determined to a voiceless sound, the specific pattern signal is extracted from the voice frame by an SND process in step S530. If no information on the input voice frame is present, the specific pattern signal is extracted from the voice frame by the SND process.

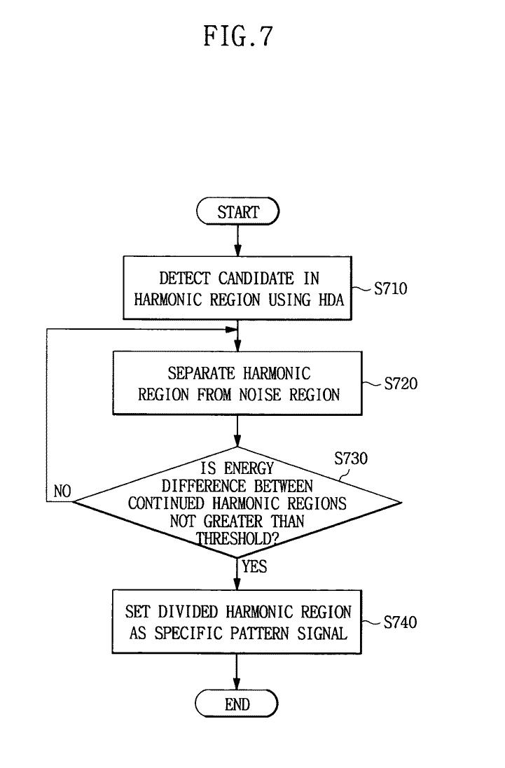

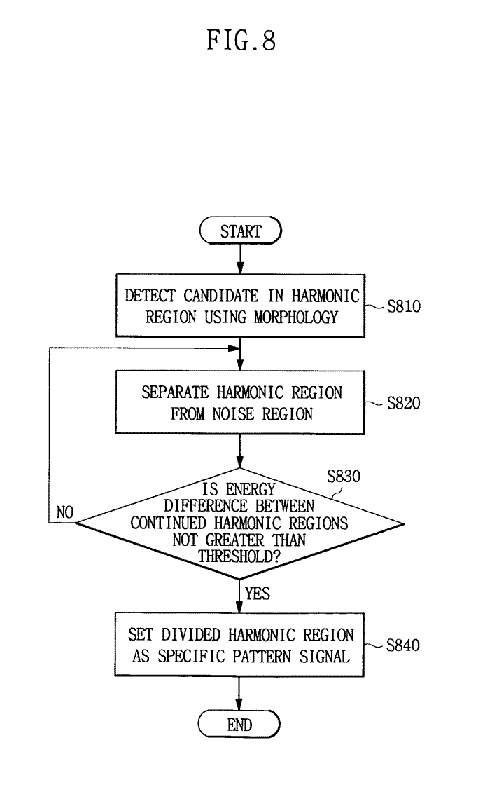

The HND process and the SND process will be described later with reference to FIGS. 7 and 8, respectively.

The specific pattern signal, extracted from the voice frame by the HND process and the SND process, is compared with information stored in the DB in step S540.

The information stored in the DB refers to information on signal patterns extracted from frame signals in a frequency range, and particularly, to information on patterns, which are statistically classified according to voice and voiceless signals. Specifically, the information stored in the DB includes a piece of information on a pattern that is present when a frame signal is a voice signal, and another piece of information on a pattern that is present when the frame signal is a voiceless signal.

When information on signal patterns extracted by the HND process and by the SND process is compared with the patterns of voice and non-voice signals stored in the DB, it is possible to determine whether an extracted signal is a voice signal or a non-voice signal in step S550. This, as a result, makes it possible to verify whether a signal, processed as a voice signal frame, is a voice signal or a voiceless signal.

If the signal is determined to be a non-voice signal in the step S550, the extracted specific pattern signal is discarded in step S560.

If the signal is determined to a voice signal in the step S550, periodicity is measured from the extracted specific pattern signal in step S570.

A method of measuring the periodicity from the extracted specific pattern signal measures the peak signal period of the maximum region of the signal after the periodicity after pre-processing, in which a signal in a cascade wave region is received from the extracted specific pattern signal, and fold-and-sum operation. This method is described in more detail in Korean Patent Application No. 10-2007-0007684 the contents of which hereby are incorporated by reference in their entirety.

In step S580, characteristic information on a speaker of the voice frame is acquired using the periodicity measured in step S570. The theoretical background capable of acquiring the characteristic information on the speaker based on the periodicity of the voice signal is as follows. People have a specific periodicity according to their own characteristics. Thus, information on a person can be obtained by detecting the periodicity of his/her voice signal. In other words, it is possible to recognize a speaker by detecting the periodicity of his/her voice signal. In addition, it is possible to predict the gender and age of a speaker based on the periodicity of a voice signal since the periodicity is different according to gender and age.

According to an exemplary embodiment of the invention, periodicity information on voice signals according to gender and age is stored in the DB, and the gender and age of a speaker can be predicted by comparing the periodicity of a voice signal, measured by the method according to an exemplary embodiment of the invention, with the periodicity information stored in the DB.

Otherwise, when periodicity information on voice signals of persons of a specific population is stored according to the persons, it is possible to identify a speaker by comparing the periodicity of a voice signal of a person belonging to the population with the periodicity information stored in the DB. In a conference, speeches can be stored according to characteristics of speakers who are present in the conference. It is also possible to discriminate the speeches according to the speakers.

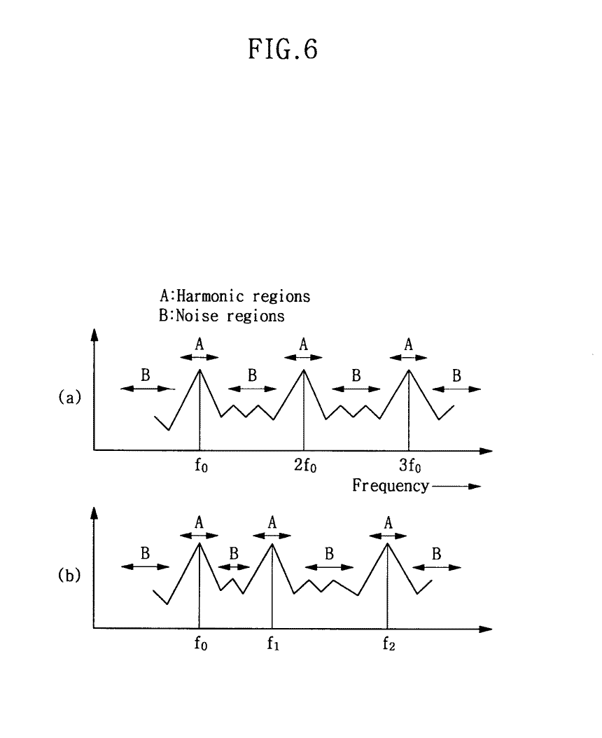

FIG. 6 illustrates graphs for a case where a harmonic region of a voice signal is periodic and a case where the harmonic region of a voice signal is aperiodic.

A harmonic region A is a region of a voice signal having meaningful information, and a noise region B is a region of a voice signal having meaningless information.

Graph (a) of FIG. 6 shows a case where the harmonic region A is periodic. Referring to graph (a), the harmonic region A is periodic, particularly, is multiple of a frequency f0. Most of the harmonic region A is periodic in the case of a voiced sound. Accordingly, a sound signal can be determined to be a voiced sound if the harmonic region A is periodic.

Graph (b) of FIG. 6 shows a case where the harmonic region A is aperiodic. Referring to graph (b), the harmonic region A is aperiodic or is not multiple of a frequency f0. Most of the harmonic region A is aperiodic in the case of a voiceless sound. Accordingly, a sound signal can be determined to be a voiceless sound if the harmonic region A is aperiodic.

FIG. 7 illustrates a flowchart for an HND process according to an exemplary embodiment of the invention.

A specific pattern signal is separated using the HND process if a voice frame is a periodic signal (i.e., a harmonic region is periodic).

If a voice signal determined to be a voiced sound is input, a harmonic region candidate is selected using HDA in S710. The HDA is an algorithm for detecting a harmonic region from a voice signal, in which an autocorrelation scheme or any conventional method can be used. Processes for detecting a harmonic region from a voice signal are well known and thus a detailed description thereof will be omitted.

Harmonic and noise regions are separated from the voice signal including a selected harmonic region candidate in step S720. The harmonic and noise regions can be separated as follows.

Zero padding is performed on the noise regions. Current harmonic samples in the harmonic regions are extrapolated to the noise regions. Then, noise sample predictions obtained by deducting the extrapolated harmonic samples from initial noise samples in the noise regions are extrapolated to the harmonic regions.

In step S730, determination on the separated harmonic region is carried out as follows. After the separating of the harmonic and noise regions, it is determined that the harmonic and noise regions are properly separated if the energy difference between continued harmonic regions drops to be the same as or smaller than a predetermined threshold. If the energy difference between the continued harmonic regions is not the same as or smaller than the predetermined threshold, the foregoing methods are repeatedly carried out by changing the noise and harmonic regions.

Next, the specific pattern signal is determined in step S740. If the energy difference between the continued harmonic regions is the same as or smaller than the threshold as a result of the determination step S70, a signal in the harmonic region is determined as the specific pattern signal.

FIG. 8 illustrates a flowchart for an SND process according to an exemplary embodiment of the invention.

The SND process selects a harmonic region candidate using morphology unlike the HDN process selecting a harmonic region candidate using the HDA in S810.

Since the input voice signal is an aperiodic voiceless signal, the SND process cannot use the HNA that is used on the assumption that a voice signal is a periodic voiced sound. Since the morphology method used in the SND can be used irrespective of whether a signal is periodic or aperiodic, the SND can use the morphology scheme. The morphology method can cause a system load since it increases the amount of data to be calculated. (However, the morphology method is more efficient than the conventional LP analysis.) Accordingly, the SND process is used only if an input signal is not a voiced sound.

The morphology method is further described in Korean Patent Application No. 10-2007-0007684.

The SND process is different from the HND process, in that the morphology method is used in place of the HDA, but the other steps are the same as those of the HND process.

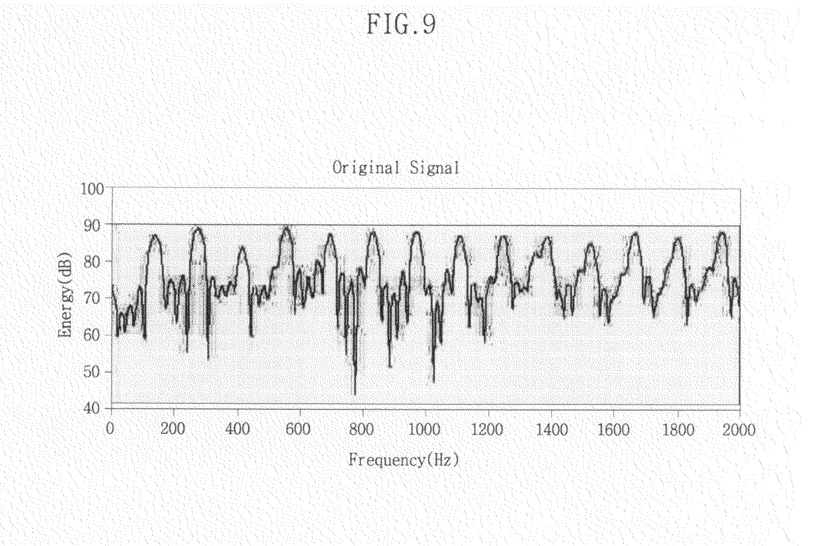

FIG. 9 illustrates a graph for a voice signal before harmonic regions are separated from noise regions by the HND or SND process according to an exemplary embodiment of the invention.

A voice signal frame is a signal in which harmonic regions containing meaningful information and noise regions containing meaningless information are mixed. FIG. 9 expresses a voice frame signal in which the harmonic regions and the noise regions are mixed.

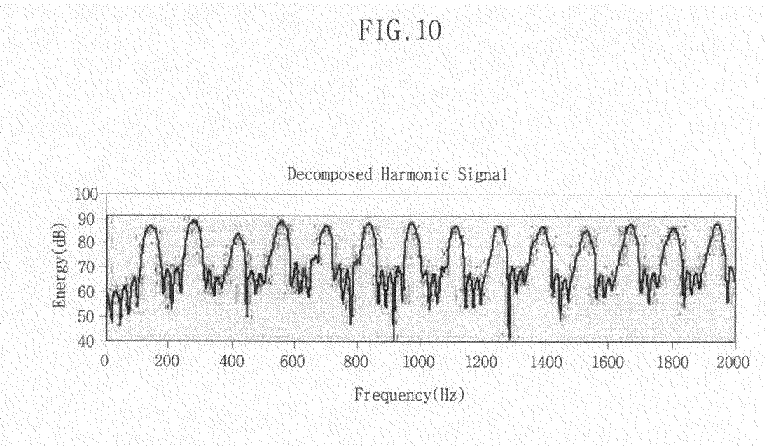

FIG. 10 illustrates a graph for a signal in harmonic regions separated by the HND or SND process according to an exemplary embodiment of the invention.

In order to detect meaningful voice information from a voice signal frame containing noises, the harmonic regions containing meaningful information are separated by the harmonic regions and the noise regions. FIG. 10 expresses the signal in the harmonic regions separated by the HND or SND process.

Referring to FIG. 10, it can be understood that the harmonic regions are clear compared to the original voice frame signal.

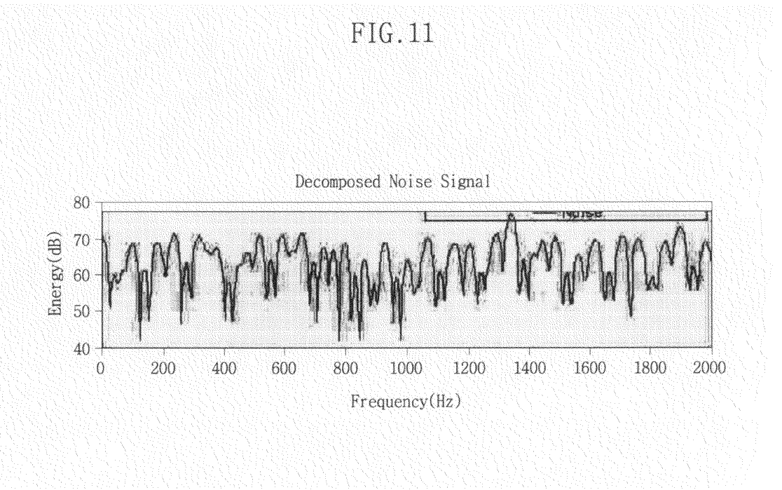

FIG. 11 illustrates a graph for a signal in the noise regions separated by the HND or SND process according to an exemplary embodiment of the invention.

FIG. 11 expresses the signal in the noise regions separated by the HND or SND process. Referring to FIG. 11, it can be understood that noises have great influence on voice information.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A speaker recognition method comprising:
separating a specific pattern signal from an input frame by analyzing the frame;
determining whether the specific pattern signal is a voice signal or a non-voice signal by comparing the specific pattern signal with information in a database, which is statistically processed;
measuring periodicity of the frame if the specific pattern signal is determined to be a voice signal; and
identifying a speaker of the frame based on the measured periodicity of the frame.

2. The speaker recognition method of claim 1, further comprising, prior to separating a specific pattern signal from an input frame, discriminating whether the frame is a voiced sound having a periodic signal or a voiceless sound having an aperiodic signal.

3. The speaker recognition method of claim 1, wherein separating a specific pattern signal from an input frame separates the specific pattern signal by harmonic-to-noise decomposition if the frame is a voiced sound and by sinusoidal-to-non-sinusoidal decomposition if the frame is a voiceless sound or no information on the frame is present.

4. The speaker recognition method of claim 3, wherein the harmonic-to-noise decomposition selects a harmonic region candidate using a harmonic detection algorithm if a harmonic region of the frame is periodic and separates the specific pattern signal using the selected harmonic region candidate.

5. The speaker recognition method of claim 3, wherein the sinusoidal-to-non-sinusoidal decomposition separates the specific pattern signal using a morphology method if the harmonic region of the frame is aperiodic.

6. The speaker recognition method of claim 5, wherein the morphology method selects an optimal window size and separates the specific pattern signal from the frame signal using the optimal window size.

7. The speaker recognition method of claim 1, wherein the database stores a result obtained by statistically processing the specific pattern signal.

8. The speaker recognition method of claim 7, wherein the result obtained by statistically processing the specific pattern signal is a result by classifying the specific pattern signal according to patterns and signal characteristics.

9. The speaker recognition method of claim 1, wherein determining whether the specific pattern signal is a voice signal or a non-voice signal compares the specific pattern signal with a voice signal in the database, and if the specific pattern signal is similar to the voice signal determines, the specific pattern signal as a voice signal.

10. The speaker recognition method of claim 1, wherein measuring periodicity of the frame measures the periodicity by performing a fold-and-sum operation on signals pre-processed from the specific pattern signal.

11. The speaker recognition method of claim 10, wherein the signals are pre-processed by removing a cascade wave component from the specific pattern signal.

12. The speaker recognition method of claim 10, wherein the fold-and-sum operation multiplies the pre-processed signals n times, sums the n times-multiplied the signals, and obtains the periodicity from a periodicity of a greatest region.

13. The speaker recognition method of claim 1, wherein the periodicity is a period of a representative signal.

14. A speaker recognition device comprising:
an input adapted to receive a voice signal frame;
a processor configured to separate a specific pattern signal by analyzing the voice signal frame;
a database that includes pattern information according to characteristics of the specific pattern signal;
a comparator configured to compare the specific pattern signal with information stored in the database;
a periodicity measurer configured to obtain periodicity of the voice signal frame from the specific pattern signal; and
a discriminator configured to identify a speaker of the voice signal from based on the periodicity.

15. The speaker recognition device of claim 14, further comprising a separator configured to determine whether the voice signal frame is a voiced sound or a voiceless sound.

16. The speaker recognition device of claim 14, wherein the processor separates the specific pattern signal using a harmonic-to-noise decomposition codec if the voice signal frame is a voiced sound and separates the specific pattern signal using a sinusoidal-to-non-sinusoidal decomposition codec if the voiced signal frame is a voiced sound or no information on the voice signal frame is present.

17. The speaker recognition device of claim 14, wherein the database is a storage medium capable of storing information, which is one selected from the group consisting of a memory device, a hard disc, and a mobile storage medium.

18. The speaker recognition device of claim 14, wherein the comparator is configured to compare the specific pattern signal with the information stored in the database, discriminate whether the specific pattern signal is a signal having voice information or a non-voice signal, forward the specific pattern signal to the periodicity measurer if the specific pattern signal is a voice signal, and discard the specific pattern signal if the specific pattern signal is a non-voice signal.

19. The speaker recognition device of claim 14, wherein the periodicity measurer is configured to measure the periodicity of the voice signal frame from the specific pattern signal using one or more digital signal processing chips.

20. The speaker recognition device of claim 19, wherein the digital signal processing chip carries out pre-processing on the specific pattern signal, carries out a fold-and-sum operation of signals produced by pre-processing the specific pattern signal, and obtains the periodicity of the voice signal frame from a peak of a greatest region produced by the fold-and-sum operation.

21. The speaker recognition device of claim 14, wherein the discriminator is configured to identify the speaker of the voice signal frame by comparing the periodicity of the voice signal frame and information of the database storing characteristics of speakers according to periodicity characteristics of the voice signal frame.

22. The speaker recognition device of claim 21, wherein the database comprises a storage medium adapted to store information, which is one selected from the group consisting of a memory device, a hard disc, and a mobile storage medium.

23. The speaker recognition device of claim 14, wherein the periodicity is period of a representative signal.
